(19) United States
(12) Patent Application Publication
(10) Pub. No.: US 2020/0162967 A1
(43) Pub. Date: May 21, 2020

(54) METHOD FOR ALLOCATING BANDWIDTH IN AN INCIDENT AREA FOR FIRST RESPONDERS

(71) Applicant: MOTOROLA SOLUTIONS, INC, Chicago, IL (US)

(72) Inventor: MARK P. ZOLLNER, PALATINE, IL (US)

(21) Appl. No.: 16/191,626

(22) Filed: Nov. 15, 2018

(51) Int. Cl. H04W 28/18; H04W 4/90; H04W 72/04; H04L 12/24; H04W 4/12

(52) U.S. Cl. CPC H04W 28/18; H04W 4/90; H04W 4/12; H04L 41/0896; H04W 72/0453

(57) ABSTRACT

A method and public safety server provide for the allocation of bandwidth in an incident area for first responders. Incident scene information is collected. A number of responder alerts is predicted based at least in part upon the incident scene information. A current loading is calculated at a site covering the incident scene. It is then determined if the site lacks enough bandwidth to provide service to the number of responder alerts. Bandwidth is then allocated at the site to provide service to the number of responder alerts.

### BACKGROUND OF THE INVENTION

Public safety officers are often placed in dangerous situations. Responder alert functionality exists to detect when certain alerts, such as shots fired, vest pierced, weapon drawn, or other serious events occur, are detected and to send messages over data and control channels. These responder alert messages need to be delivered quickly and reliably to dispatchers or CAD operators. Unfortunately, when incidents are occurring there is typically a surplus of traffic on the data and control channels. This can lead to insufficient bandwidth on the data and control channels to send responder alerts when they are most urgently needed to be delivered.

Therefore, a need exists for a method and system to allow responder alerts to be sent quickly and reliably.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a communication system in accordance with an exemplary embodiment.

FIG. 2 depicts a schematic of a call controller in accordance with an exemplary embodiment.

FIG. 3 depicts a flowchart in accordance with an exemplary embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An exemplary embodiment uses information about an incident scene and the responders dispatched to the scene to predict the number of responder alerts that will be generated. If the current state of the communication network does not provide enough bandwidth for the predicted number of responder alert messages, the communication network allocates additional bandwidth to ensure that responder alert messages are not blocked or delayed. In this manner, responder alert messages are sent quickly and reliably, thereby providing enhanced reliability and safety for first responders.

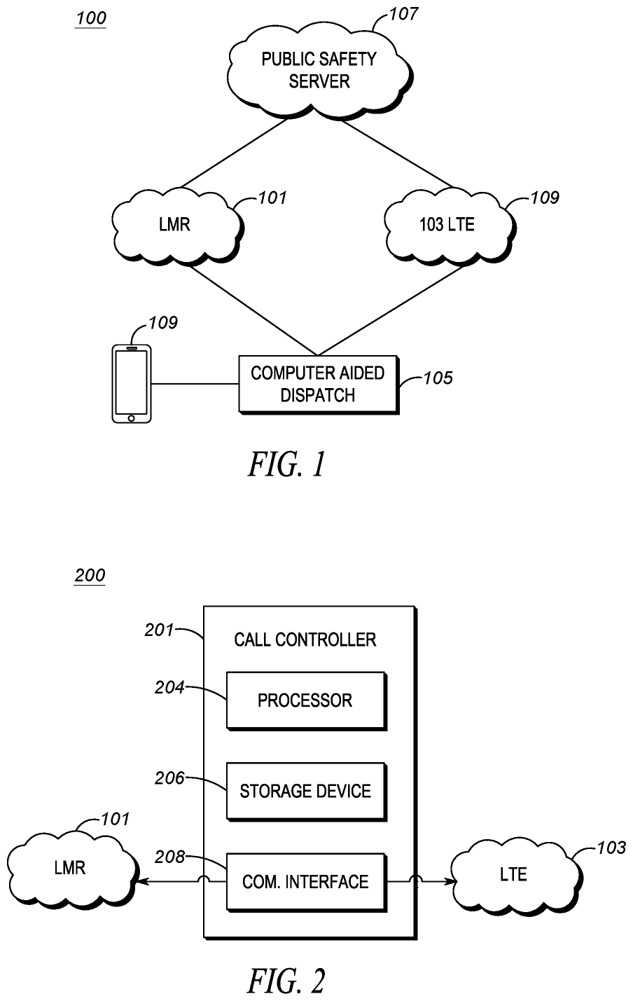

FIG. 1 depicts a system diagram of a communication system 100 in accordance with an exemplary embodiment of the present invention. Communication system 100 preferably includes a Land Mobile Radio (LMR) network 101, a Long Term Evolution (LTE) network 103, a Computer Aided Dispatch (CAD) terminal 105, a Public Safety Server 107, and a communication devices 109. Communication device 109 is sometimes referred to as a subscriber unit.

LMR network 101 is a terrestrially-based, wireless communications system. LMR network 100 preferably includes communication devices, such as communication device 109, base stations, a network, and repeaters. In accordance with an exemplary embodiment, LMR network 101 includes a call controller 200, depicted in more detail in FIG. 2 below. The base stations are typically located in fixed positions, such as public safety answering points (PSAP) or dispatch centers.

LTE network 103 is a wireless network. A core network within LTE network 103 handles overall control of communication devices within LTE network 103. The core network typically comprises a PDN Gateway (P-GW), a Serving Gateway (S-GW), Mobility Management Entity (MME), a Home Subscriber Server (HSS), and the Policy Control and Charging Rules Function (PCRF). An access network of LTE, commonly referred to as E-UTRAN, typically comprises a network of eNodeBs, not shown for clarity purposes.

CAD terminal 105 provides for computer aided dispatch to public safety employees and other first responders. Dispatchers utilizing CAD terminal 105 are able to easily view and understand the status of all communication devices being dispatched. CAD terminal 105 preferably provides displays and tools so that the dispatcher has an opportunity to handle calls-for-service as efficiently as possible. A dispatcher preferably tells call controller 201 how many officers were dispatched to the incident scene, an identification of each officer, the location of the scene, or the type of scene, such as whether the incident scene is a domestic violence incident, a robbery, a hostage situation, or any similar situation.

Public Safety Server 107 is a server or cloud connection that includes crime and police data. Public Safety Server 107 is connected to LMR network 101 and LIE network 103 and is able to send and receive data therebetween.

In an exemplary embodiment, communication device 109 can send and receive data and voice communications to LMR network 101. In an alternate exemplary embodiment, communication device 109 can send and receive data and voice communications to LTE network 103. In a further alternate exemplary embodiment, communication device 109 is a dual-mode communication device that can send and receive data and voice communications to LR network 101 and LTE network 103. It should be understood that a typical communication system would include hundreds and even thousands of communication devices, but only one is depicted in FIG. 1 for clarity.

FIG. 2 depicts a schematic of a call controller 201 in accordance with an exemplary embodiment. In the example provided, call controller 201 includes an electronic processor 204, a storage device 206, and a communication interface 208. Electronic processor 204, storage device 206, and communication interface 208 communicate over one or more communication lines or buses. Wireless connections or a combination of wired and wireless connections are also possible.

Electronic processor 204 may include a microprocessor, application-specific integrated circuit (ASIC), field-programmable gate array, or another suitable electronic device. Electronic processor 204 obtains and provides information (for example, from storage device 206 and/or communication interface 208), and processes the information by executing one or more software instructions or modules, capable of being stored, for example, in a random access memory (“RAM”) area of storage device 206 or a read only memory (“ROM”) of storage device 206 or another non-transitory computer readable medium (not shown). The software can include firmware, one or more applications, program data, filters, rules, one or more program modules, and other executable instructions. Electronic processor 204 is configured to retrieve from storage device 206 and execute, among other things, software related to the control processes and methods described herein.

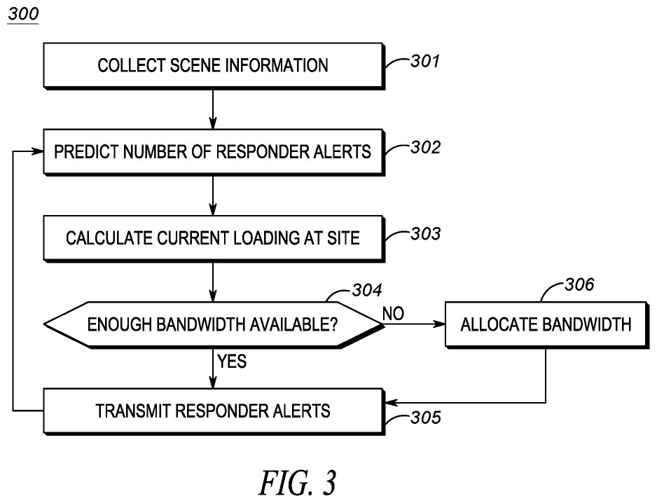

Storage device 206 can include one or more non-transitory computer-readable media, and may include a program storage area and a data storage area. The program storage area and the data storage area can include combinations of different types of memory, as described herein. In the embodiment illustrated, storage device 206 stores, among other things, instructions for the processor to carry out the methods of FIG. 3.

Communication interface 208 may include a transceiver (for example, an LTE modem, an FM transceiver, or a Wi-Fi or Ethernet transceiver) for communicating over one or more wired or wireless communication networks (for example, LMR network 101 or LTE network 103) or connections.

In accordance with an exemplary embodiment, call controller 201 combines the information received from the CAD 105 along with historical crime and police data from Public Safety Server 107 and plugs the combined information it into a machine learning model to predict the bandwidth needed for the responder alert traffic.

FIG. 3 depicts a flowchart 300 of a method for allocating bandwidth in an incident area for first responders in accordance with an exemplary embodiment of the present invention.

Call controller 201 collects (301) scene information from the incident area. Examples of scene information include incident type, suspect information, police dispatched to the scene, and weapons being used by officers. The incident type can be, for example, assault, domestic abuse, armed robbery, etc. The suspect information can preferably include age, inebriated, gang affiliation, etc. Police officers dispatched to the scene can preferably include number of officers, age of officers, experience of officers, number of hours officer received training, etc. Weapons being used by officers can include, for example, taser, gun, gun type, etc.

Call controller 201 predicts (302) the number of responder alerts that will be generated at this scene. In accordance with an exemplary embodiment, call controller 201 uses information about the incident situation to predict the number of responder alerts that will be generated. In an exemplary embodiment, the predicted number of responder alerts includes the expected number of responders who have yet to arrive at the incident scene. In an alternate exemplary embodiment, the predicted number of responder alerts includes the responders currently at the site as well as the expected number of responders who have yet to arrive at the incident scene.

Call controller 201 calculates (303) the current loading at the site. In an exemplary embodiment, call controller 201 calculates the load by determining the amount and rate of voice and mobility traffic currently occurring at the site from the control channel perspective. From the data channel perspective, the load is calculated by the amount and rate of data messages.

Call controller 201 determines (304) if there is enough bandwidth available to transmit successfully the predicted number of responder alerts at the site and in a timely manner, relative to all the other traffic on the control and data channel. In an exemplary embodiment, this determination is made using the responders who are currently at the incident scene in addition to the responders who are expected to arrive at the incident scene. Alternately, this determination can be made by determining the responders expected to arrive at the incident scene but who have not yet arrived. In an exemplary embodiment, there may be some amount of time that elapses before the alerts are transmitted. The idea is to prepare the scene so that it has enough bandwidth once the responders do arrive.

If there is enough bandwidth available as determined at step 304, call controller 201 transmits (305) the responder alerts as they are generated by the responders.

If there is not enough bandwidth available as determined at step 304, call controller 201 allocates (306) bandwidth at the incident scene to be utilized by responder alerts. In accordance with an exemplary embodiment, control channel bandwidth, in particular inbound control channel bandwidth, can be reserved temporarily to be used for responder alerts. A first exemplary embodiment of reserving control channel bandwidth comprises disallowing non-essential talkgroups at the incident site, for example non-police talkgroups or public works talkgroups. A further exemplary embodiment of reserving control channel bandwidth comprises disabling subscriber authentication. The subscriber authentication is preferably turned back on when the incident ends. A further exemplary embodiment of reserving control channel bandwidth comprises disabling radio timeout checks. Further exemplary embodiments of reserving control channel bandwidth comprise disallowing non-essential personnel from roaming into or registering at the site.

In accordance with a second exemplary embodiment, data channel bandwidth can be reserved temporarily to be used for responder alerts. Reserving data channel bandwidth can be accomplished via disabling text messaging or disabling location updates of non-essential users, for example.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for allocating bandwidth in an incident area for first responders, the method comprising:
collecting incident scene information;
predicting a number of responder alerts based at least in part upon the incident scene information;
calculating a current loading at a site covering the incident scene;
determining if the site lacks enough bandwidth to provide service to the number of responder alerts; and
allocating bandwidth at the site to provide service to the number of responder alerts.

2. The method of claim 1, wherein the scene information comprises an incident type.

3. The method of claim 2, wherein the incident type comprises a type of crime committed.

4. The method of claim 1, wherein the scene information comprises suspect information.

5. The method of claim 1, wherein the scene information comprises information about police officers dispatched to the incident area.

6. The method of claim 1, wherein the scene information comprises information about a number of victims at the incident area.

7. The method of claim 1, wherein the scene information comprises an indication that weapons were used by police officers

8. The method of claim 1, wherein the step of allocating bandwidth comprises limiting control channel bandwidth.

9. The method of claim 8, wherein the step of limiting control channel bandwidth comprises limiting inbound control channel bandwidth.

10. The method of claim 8, wherein the step of limiting control channel bandwidth comprises disabling subscriber authentication.

11. The method of claim 8, wherein the step of limiting control channel bandwidth comprises disabling radio timeout checks.

12. The method of claim 8, wherein the step of limiting control channel bandwidth comprises disallowing non-essential personnel from roaming into the site.

13. The method of claim 8, wherein the step of limiting control channel bandwidth comprises disallowing non-essential personnel from registering at the site.

14. The method of claim 1, wherein the step of allocating bandwidth comprises limiting data channel bandwidth.

15. The method of claim 14, wherein the step of limiting data channel bandwidth comprises disabling text messaging.

16. The method of claim 14, wherein the step of limiting data channel bandwidth comprises disabling location updates of non-essential users.

17. A call controller comprising:
a communication interface that collects incident scene information; and
a processor that performs:
predicting a number of responder alerts based at least in part upon the incident scene information;
calculating a current loading at a site covering the incident scene;
determining if the site lacks enough bandwidth to provide service to the number of responder alerts; and
allocating bandwidth at the site to provide service to the number of responder alerts.

18. The call controller of claim 17, wherein the processor performs the step of allocating bandwidth by limiting control channel bandwidth.

19. The call controller of claim 17, wherein the processor performs the step of allocating bandwidth by limiting data channel bandwidth.

20. The call controller of claim 19, wherein the processor performs the step of limiting data channel bandwidth by at least one of disabling text messaging or disabling location updates of non-essential users.
